(19) United States
(12) Patent Application Publication
(10) Pub. No.: US 2022/0034131 A1
(43) Pub. Date: Feb. 3, 2022

(54) DOOR STOP ROD WITH WARNING FUNCTION

(71) Applicant: YAO-KUN YANG, Taichung City (TW)

(72) Inventor: YAO-KUN YANG, Taichung City (TW)

(21) Appl. No.: 16/941,538

(22) Filed: Jul. 29, 2020

(51) Int. Cl. E05C 17/16; E05C 17/30; E05B 45/06

(52) U.S. Cl. CPC E05C 17/166; E05B 2045/0625; E05B 45/06; E05C 17/30

(57) ABSTRACT

A door stop rod with warning function for anti-theft assistance on a door lock. The door stop stand includes a clamping holder and an early warning device. The clamping holder includes an accommodation chamber, and an assembly section and a door clamping part disposed on two opposite sides thereof. The assembly section is combined with an end of a stop rod, and the door clamping part includes a clamping part for clamping the door lock. The early warning device is disposed in the accommodation chamber and includes a control circuit, a power supply device, a buzzer, and a vibration detection device. When the vibration detection device detects vibration of the door lock, the control circuit controls the buzzer to make a warning sound, so as to warn people indoors to respond countermeasures, call police or ask for help early, thereby effectively protecting safety of lives and property.

### BACKGROUND OF THE INVENTION

### 1. Field of the Invention

The present invention relates to a technical field of anti-theft door stop rod device, and more particularly to a door stop rod with a warning function.

### 2. Description of the Related Art

Many types of anti-theft countermeasures for doors are available in markets, and the most common one is knob. However, the knob is easy to be opened and the key of the knob is easy to leak, so the property in the house may be easy to be stolen or people in the house are easily bothered or harassed even the house is installed with the knob. Therefore, many people install door stop rods on the inner side of the door to protect the safety of people and property indoors.

Many companies also develop door stop devices for consumers' selection. For example, Taiwan utility model patent No. M413011 discloses that the door stop rod can also e used as a crutch to provide better functionality. Another example is Taiwan utility model patent No. M367224, which further provides a solution to the inconvenience of storing and stowing conventional doorstop devices, so as to achieve better storage convenience.

However, the above-mentioned patents only provide the conventional door stop rod with extension peripheral use function, other than anti-theft function, for the effect of convenient use; they have not further improved the anti-theft function of the convention door stop rod, and it may be insufficient to resist the increasingly renovated theft skills by only using the stop rod to assist anti-theft effect of the door lock, and the door lock is still easy to be broken by thieves and cannot protect the safety of lives and property of people indoors.

### SUMMARY OF THE INVENTION

An objective of the present invention is to dispose an early warning device in a clamping holder of a stop rod to detect outside vibration; in response to the detected vibration, the early warning device can make a warning sound to warn people indoors to respond countermeasures, call police or ask for help as soon as possible, thereby effectively protecting the safety of lives and property.

In order to achieve aforementioned objective and effect, the present invention provides a door stop rod with a warning function for anti-theft assistance on a door lock disposed on a door panel, and the door stop rod includes a clamping holder and an early warning device. The clamping holder includes an accommodation chamber, and an assembly section and a door clamping part disposed on two opposite sides thereof. The assembly section is combined with an end of a stop rod, and the door clamping part includes a clamping part. The early warning device is disposed in the accommodation chamber, and includes a control circuit, a power supply device, a buzzer, and a vibration detection device which are electrically connected to each other. The control circuit can control the buzzer to make a warning sound when the vibration detection device detects outside vibration.

### BRIEF DESCRIPTION OF THE DRAWINGS

The structure, operating principle and effects of the present invention will be described in detail by way of various embodiments which are illustrated in the accompanying drawings.

FIG. 1 is a perspective assembly view of a door stop rod of the present invention.

FIG. 2 is a perspective exploded view of a door stop stand of the present invention, when a sealing cover is separated from a clamping holder of the door stop rod.

FIG. 3 is a perspective exploded view of a clamping holder, a stop rod and an early warning device of the present invention.

FIG. 4 is a schematic view of a usage status of a door stop rod providing anti-theft assistance on a door lock, according to the present invention.

FIG. 5 is a schematic plan view of an early warning device electrically connected to an electrode sheet disposed on a clamping part of the present invention, when a sealing cover is separated from a clamping holder.

FIG. 6 is a schematic plan view of two clamping sections movably assembled with a clamping part by inserting and pivotally connecting pivot pins to two sides of the clamping part respectively, according to the present invention.

FIG. 7 is a schematic plan view of a usage status of two clamping sections elastically swung to clamp a neck part of a door lock, according to the present invention.

FIG. 8 is an exploded view of an inner tube and an outer tube of a stop rod of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

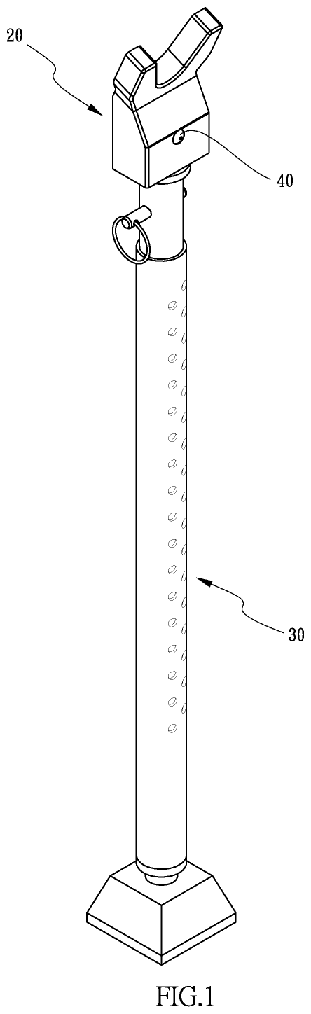

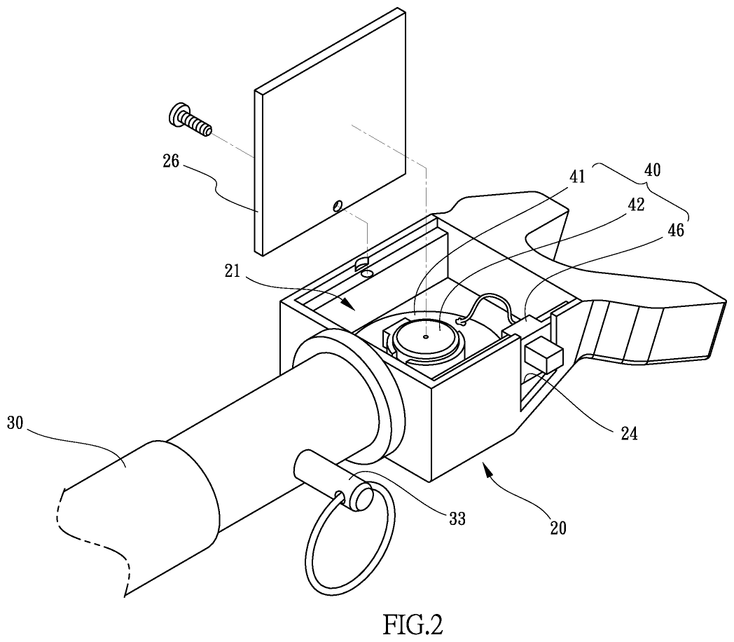

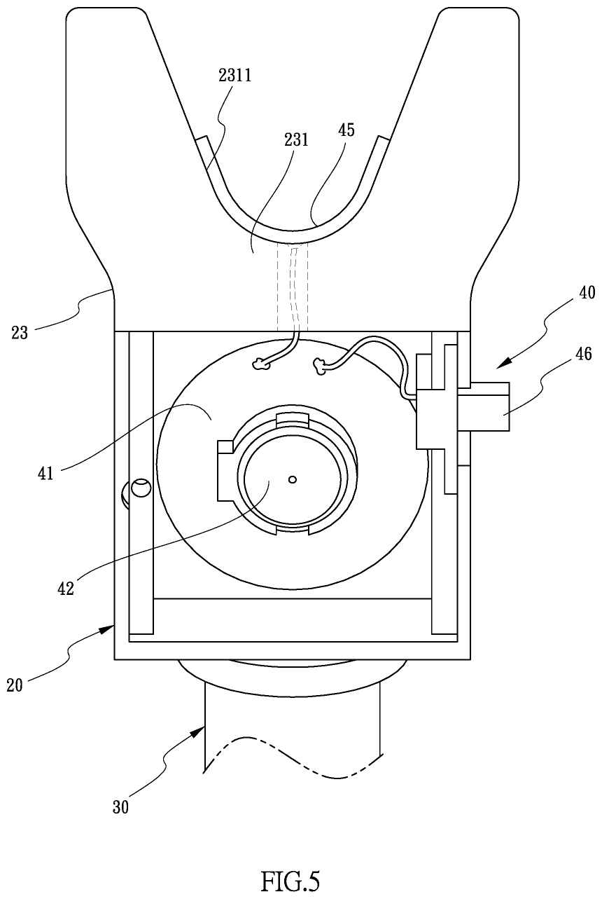

Please refer to FIGS. 1 to 6. According to the present invention, a door stop rod with a warning function can provide anti-theft assistance on a door lock 11 disposed on a door panel 10, and the door stop rod include a clamping holder 20 and an early warning device 40.

The clamping holder 20 includes an accommodation chamber 21, and an assembly section 22 and a door clamping part 23 disposed on two opposite sides thereof. The assembly section 22 is combined with an end of a stop rod 30, and the door clamping part 23 includes a clamping part 231 used to clamp the door lock 11 for fastening.

The early warning device 40 is disposed in the accommodation chamber 21 and includes a control circuit 41, a power supply device 42, a buzzer 43, and a vibration detection device 44, which are electrically connected to each other. When the vibration detection device 44 detects vibration of the door lock 11, the control circuit 4 controls the buzzer 43 to make a warning sound.

The aforementioned contents are the main technical features of the main embodiment of the present invention, and the main technical features correspond to content of claim 1 of the patent invention, to explain the purpose and implementation of the present invention in detail; the technical features described in the dependent claims are the detailed description of the content of claim 1 or appended technical features, and not to limit the scope of claim 1 of the patent invention. It should be noted that claim 1 is not necessarily to include the technical features described in dependent claims.

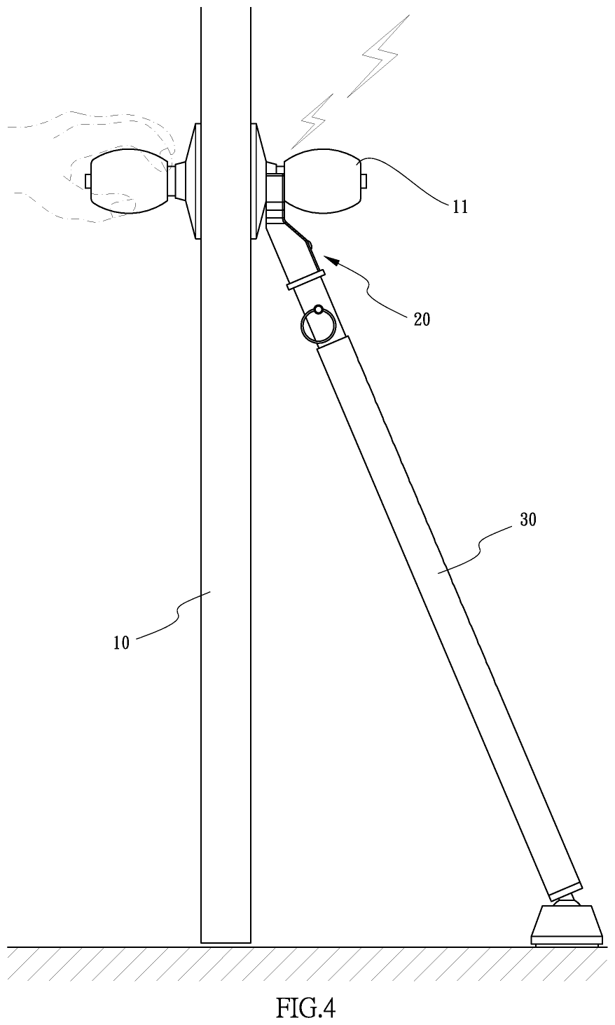

According to the above description, as shown in FIG. 4, in order to use the door stop rod of the present invention, the door clamping part 23 of the clamping holder 20 is used to clamp the door lock 11 for fastening, and then the anti-slip member on other end, opposite to the assembly section 22, of the stop rod 30 is pushed against ground, so as to strengthen the force supporting the door panel 10 with better stability. Furthermore, with configuration of the early warning device 40 disposed in the accommodation chamber 21 of the clamping holder 20, when the vibration of the door lock 11 is detected, the control circuit 41 of the early warning device 40 can control the buzzer 43 to make a warning sound, so as to warn people indoors to early respond countermeasure, such as calling police or asking for help, thereby effectively protecting the safety of lives and property.

The features of elements of the present invention are described in detail below. As shown in FIGS. 1 to 6, the clamping part 231 includes a concave surface 2311 formed in a concave space, the early warning device 40 includes an electrostatic induction device 48 and an electrode sheet 45 which are electrically connected to the control circuit 41, and the electrode sheet 45 is disposed on a concave surface 2311 of the clamping part 231 to contact the door lock 11. Because the door lock 11 is generally made of metal material for anti-theft, when a thief contacts the door lock 11 and tries to break the door lock 11 without wearing gloves, the above configuration may enable the electrode sheet 45 to receive static electricity, which is conducted through the door lock 11 and caused by the thief's contact, to trigger the electrostatic induction device 48, the control circuit 41 can control the buzzer 43 to make a warning sound, so as to warn people indoors to respond countermeasures earlier. Furthermore, the clamping holder 20 can include a lateral connection groove 24 in communication with a side of the accommodation chamber 21, the early warning device 40 can include a switch 46 assembled in the lateral connection groove 24 and electrically connected to the control circuit 41, The switch 46 can be used to turn on or off the early warning device 40. The clamping holder 20 can include an indicator hole 25 in communication with to a side of the accommodation chamber 21, and the early warning device 40 can include an indicator light 47 aligned to the indicator hole 25 and electrically connected to the control circuit 41, so that the indicator light can show that the early warning device 40 is turned on or off.

The clamping holder 20 can include a sealing cover 26 configured to cover an opening of the accommodation chamber 21 to cover the early warning device 40 disposed in the accommodation chamber 21. The door clamping part 23 includes two clamping sections 232 connected on two ends of the clamping part 231, respectively.

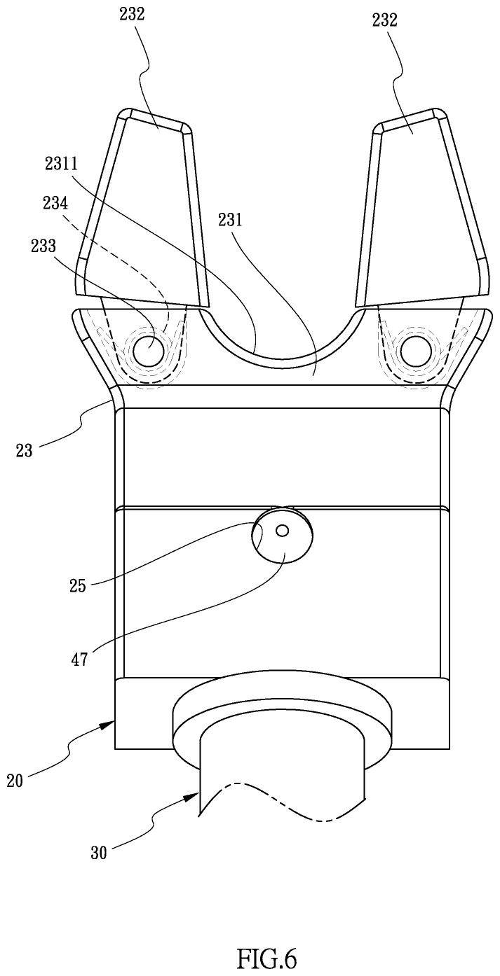

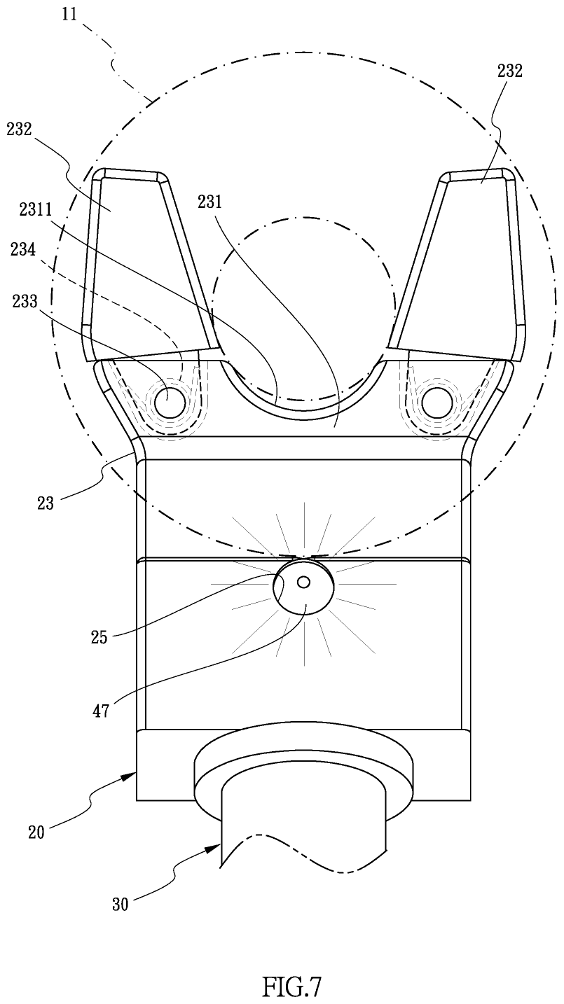

As shown in FIGS. 6 and 7, the door clamping part 23 can include two clamping sections 232 normally pivotally swung toward the approaching directions, so that the two clamping sections 232 can elastically clamp the door lock 11 with different size after the two clamping sections 232 are pivotally swung by elastic recovery. As shown in FIG. 7, in this embodiment, pivot pins 233 are inserted through and movably pivoted with the two clamping sections 232, respectively; torque springs 234 are inserted through and assembled with the pivot pins 233, respectively, so as to elastically push the two clamping sections 232 to pivotally swing toward the approaching directions in a normal status.

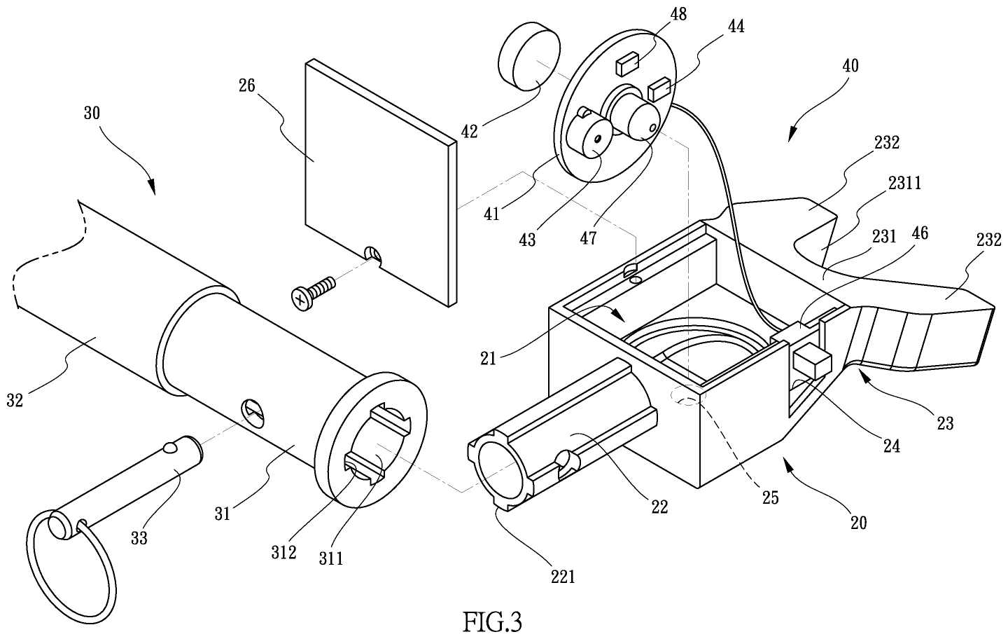

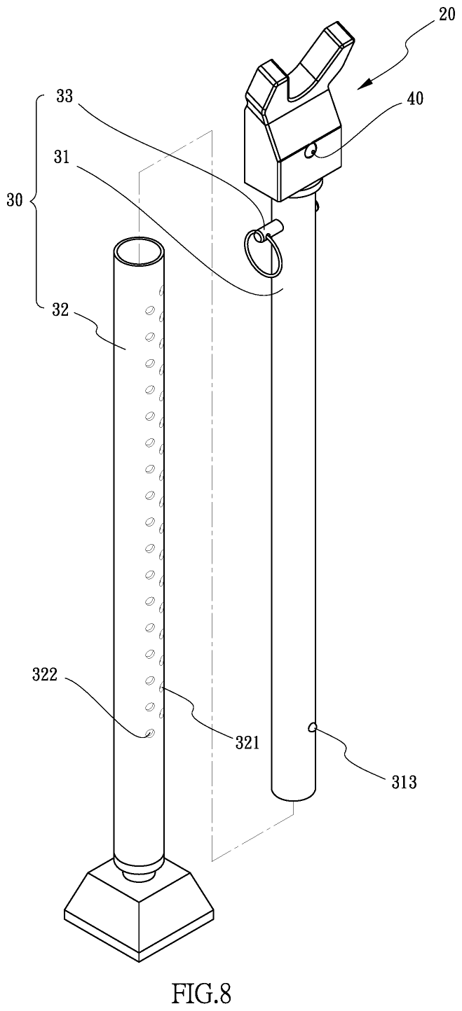

Furthermore, as shown in FIGS. 3 and 8, the stop rod 30 can include an inner tube 31 and an outer tube 32 which are telescopically mounted with each other, and the inner tube 31 is mounted with the assembly section 22 by an end, which is opposite to the outer tube 32, thereof. Furthermore, the assembly section 22 has a plurality of restraining ribs 221 protruded on the outer peripheral side thereof, and the inner tube 31 has a mounting hole 311 mounted with the assembly section 22, and a plurality of restraining grooves 312 axially arranged on an inner tube wall thereof; the plurality of restraining ribs 221 are respectively mounted in the plurality of restraining groove 312 to restrain a radial rotation, so as to strengthen the firmness of the clamping holder 20 clamping the door lock 11. The stop rod 30 includes a dowel pin 33 inserted through and assembled with the inner tube 31 and the assembly section 22 which are mounted with each other, so as to strengthen the firmness of the stop rod 30 combined with the clamping holder 20 to clamp the door lock 11.

As shown in FIG. 8, the inner tube 31 includes an elastic fastener 313 elastically exposed out of the outer surface thereof, the outer tube 32 includes a plurality of through holes arranged in interval to form a first locating hole group 321 and a second locating hole group 322. The second locating hole group 322 is arranged in parallel with and aside the first locating hole group 321, and each of the through holes of the second locating hole group 322 is disposed between any adjacent two of the through holes of the first locating hole group 321, and the elastic fastener 313 of the inner tube 31 is elastically exposed out of and engaged with one of the through holes of the first locating hole group 321 and the second locating hole group 322, so as to fasten a telescopic length of the inner tube 31 and the outer tube 32. With the arrangement of the first locating hole group 321 and the second locating hole group 322, the adjustment steps of the telescopic length of the inner tube 31 and the outer tube 32 can be increased effectively, so as to improve usability of the door stop rod of the present invention, and prevent the structural strength of the outer tube from being affected because of too close hole distance.

As described above contents of the present invention, the early warning device 40 disposed in the accommodation chamber 21 of the clamping holder 20 can be used to indeed solve the problem and drawback of the existing door stop rod being easily broken by thieves, so as to achieve the following advantages:

First, when the vibration detection device 44 detects vibration of the door lock 11, the control circuit 41 of the early warning device 40 can control the buzzer 43 to make a warning sound, so as to warn people indoors to earlier respond, call the police or ask for help.

Secondly, when a thief contacts the door lock 11 to break the door lock 11 without wearing gloves, the electrode sheet 45 can receive outside contact static electricity conducted through the door lock 11, to trigger the electrostatic induction device 48, the control circuit 41 can control the buzzer 43 to make a warning sound, so as to warn people indoors to respond countermeasures earlier.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A door stop rod with a warning function, comprising:
a clamping holder comprising an accommodation chamber, and an assembly section and a door clamping part disposed on two opposite sides thereof, wherein the assembly section is combined with an end of a stop rod, and the door clamping part comprises a clamping part; and
an early warning device disposed in the accommodation chamber, and comprising a control circuit, a power supply device, a buzzer, and a vibration detection device which are electrically connected to each other, wherein the control circuit is configured to control the buzzer to make a warning sound when the vibration detection device detects outside vibration.

2. The door stop rod according to claim 1, wherein the clamping part comprises a concave surface formed in a concave space, the early warning device further comprises an electrostatic induction device and an electrode sheet which are electrically connected to the control circuit, the electrode sheet is disposed on the concave surface of the clamping part, and when the electrode sheet detects outside contact static electricity and triggers the electrostatic induction device, the control circuit controls the buzzer to make a warning sound.

3. The door stop rod according to claim 2, wherein the clamping holder comprises a lateral connection groove in communication with a side of the accommodation chamber, the early warning device comprises a switch assembled in the lateral connection groove and electrically connected to the control circuit, and the switch is configured to turn on or off of the early warning device.

4. The door stop rod according to claim 2, wherein the clamping holder comprises an indicator hole in communication with to a side of the accommodation chamber, the early warning device further comprises an indicator light aligned to the indicator hole and electrically connected to the control circuit, and the indicator light is configured to show that the early warning device is turned on or off.

5. The door stop rod according to claim 1, wherein the clamping holder comprises a sealing cover configured to cover an opening of the accommodation chamber and cover the early warning device disposed in the accommodation chamber, and the door clamping part comprises two clamping sections connected on two ends of the clamping part, respectively.

6. The door stop rod according to claim 1, wherein the door clamping part comprises two clamping sections pivotally swingable toward approaching directions normally, and the two clamping sections are configured to elastically clamp after the two clamping section are pivotally swung by elastic recovery.

7. The door stop rod according to claim 1, wherein the stop rod comprises an inner tube and an outer tube which are telescopically mounted with each other, and the inner tube is mounted with the assembly section by an end, which is opposite to the outer tube, thereof.

8. The door stop rod according to claim 7, wherein the assembly section comprises a plurality of restraining ribs protruded on an outer peripheral side thereof, the inner tube has a mounting hole mounted with the assembly section, and a plurality of restraining grooves axially arranged on an inner tube wall thereof, and the plurality of restraining ribs are mounted in the plurality of restraining grooves, respectively.

9. The door stop rod according to claim 7, wherein the stop rod comprises a dowel pin inserted into and assembled with the inner tube and the assembly section which are mounted with each other.

10. The door stop rod according to claim 7, wherein the inner tube comprises an elastic fastener elastically exposed out of the outer surface, the outer tube comprises a plurality of through holes arranged in interval and forming a first locating hole group and a second locating hole group, the second locating hole group is arranged in parallel with and aside the first locating hole group, and each of the through holes of the second locating hole group is disposed between any adjacent two of the through holes of the first locating hole group, and the elastic fastener of the inner tube is elastically exposed out of and engaged with one of the through holes of the first locating hole group and the second locating hole group, so as to fasten a telescopic length of the inner tube and the outer tube.
